(19) United States
(12) Patent Application Publication
(10) Pub. No.: US 2026/0097358 A1
(43) Pub. Date: Apr. 9, 2026

(54) TWO-MEMBRANE STAGE SYSTEM WITHOUT INTERMEDIATE COMPRESSOR SYSTEM FOR HIGH H2S NATURAL GAS SEPARATION

(71) Applicants: L'Air Liquide, Société Anonyme pour l'Etude et l'Exploitation des Procédés George Claude, Paris (FR); Saudi Aramco Technologies Company, Dhahran (SA)

(72) Inventors: Shilu FU, Newark, DE (US); Sudhir KULKARNI, Wilmington, DE (US); Liren XU, Bear, DE (US); Garba YAHAYA, Dhahran (SA); Feras HAMAD, Dhahran (SA); Faisal I. JASSIM, Al-Jubail (SA)

(21) Appl. No.: 18/905,751

(22) Filed: Oct. 3, 2024

(51) Int. Cl. B01D 53/22

(52) U.S. Cl. CPC B01D 53/226; B01D 2256/245; B01D 2257/304; B01D 2257/504; B01D 2257/80

(57) ABSTRACT

A system for high acidic natural gas separation comprises a first membrane stage, configured to separate a feed of the high acidic natural gas into a first permeate stream and a first residue stream; a second membrane stage, connected to the first membrane stage in series, configured to separate the first permeate stream from the first membrane stage into a second residue stream, recycled back to the feed, and a second permeate stream, sent to a SRU to recover sulfur; and a compressor, configured to compress the second residue stream from the second membrane stage to a pressure slightly greater than a pressure of the natural gas feed to the first membrane stage, wherein the compressed second residue stream is recycled back and combined with the natural gas feed to form the feed of the first membrane stage.

### TECHNICAL FIELD

The present invention relates to a two-membrane stage separation system for high acidic natural gas separation without using a compressor in between the two membrane stages, in particular, a two-membrane stage separation system for reducing high concentrations of H₂S in natural gas without using a compressor in between the two membrane stages, in which a pressure of the first membrane stage permeate is greater than 4 bar or 60 psia.

### BACKGROUND

Natural gas sweetening is the process of removing hydrogen sulfide (H₂S) and carbon dioxide (CO₂) from natural gas to make it suitable for transportation and sale. In the Middle East, there are highly sour natural gas (NG) reserves that contain H₂S and CO₂ up to 30% and 10%. Russia NG fields at Astrakhan also contain 25% H₂S and 15% CO₂. The sales gas pipeline specifications may mandate less than 4 ppm of H₂S, which exerts heavy financial and operational stress on gas producers according to Hamad et al., “Treatment of highly sour natural gas stream by hybrid membrane-amine process: Techno-economic study”, Separation and Purification Technology, 237, p116348, 2020. Furthermore, the high acid gas content complicates the treatment process due to material degradation, corrosion and safety requirements.

NG sweetening is one of the most critical processes for NG treatment. The most widely applied technologies include absorption, pressure swing adsorption (PSA), cryogenic condensation, etc. These conventional technologies are generally associated with high energy requirements and capital cost (Afnan et al., “High pressure pure- and mixed sour gas transport properties of Cardo-type block co-polyimide membranes”, Journal of Membrane Science, 553, p32-42, 2018). For instance, an amine process followed by a sulfur recovery unit (SRU) to recover sulfur, is a well-developed technology to provide deep cleaning to bring H₂S content down to 4 ppm. However, especially when high acid gas load is involved, this process requires a high circulation rate of amine solution. This results in higher corrosion rate and less stable operation of the amine contactors. More than one regeneration train might be needed, resulting in both higher OPEX and CAPEX (Baker et al., “Natural gas processing with membranes: an overview”, Ind. Eng. Chem. Res. 47 (2008) 2109-2121).

Membrane, on the other hand, is potentially higher energy efficient, smaller footprint, and lower capital cost (Spillman, “Economics of gas separation membranes”, Chem. Eng. Progress, 85, 41-62, 1989). Also membranes are modular. Membrane schemes can be designed to handle significant deviations in flow rates and acid gas loadings. However, membrane technology has its own drawbacks. It is generally considered as a bulk removal treatment. Polishing a highly sour NG stream to a 4 ppmv H₂S product stream is impractical for membranes as stand-alone technology. Also, more than one membrane stage process might have to be applied to avoid high hydrocarbon losses. Furthermore, compression might be needed if not enough driving pressure is available.

U.S. Pat. No. 8,801,832 to Vaidya et al. discloses utilizing a hybrid membrane-amine-sulfur recovery unit process to treat highly sour NG. In this process, the sour NG stream is first fed to a membrane process, from which most of the acid gas is removed into the permeate stream. The remaining acid gas, along with the residue, is sent to the amine process. The amine process removes the remaining acid gas and vents it in an amine regeneration unit, after which it consolidates with the permeate stream to form the feed to SRU. This hybrid process may provide an attractive economic alternative to treat highly sour NG.

There are studies on hybridized membrane-amine processes that can be reflected on. Baker et al., (Natural Gas Processing with Membranes: An Overview”, Ind. Eng. Chem. Res. 2008, 47, 2109-2121) shows that operating a membrane process upstream of an absorption process (amine or hot potassium) has reduced the required absorption process trains to only one, in comparison to two trains if stand-alone absorption process is deployed. The stand-alone absorption process CAPEX is higher by 10 to 20%, and the process OPEX is substantially higher by 70 to 80%, in comparison to the hybridized process. A parametric simulation study of absorption processes against hybrid membrane processes has been conducted by Bhide et al. (Hybrid processes for the removal of acid gases from natural gas. Journal of Membrane Science 140 (1998) 27-49). The choice of membrane process system depends on several factors: the membrane perm-selectivity characteristics, the acid content of the feed gas, the desired hydrocarbon recovery, degree and purity of the acid gas concentrated stream(s), recompression costs, membrane module and skid costs etc. The membrane process itself may have multiple membrane stages, use membranes of varying perm-selectivities, and use varying recycle and recompression schemes

Hao et al., (“Upgrading low-quality natural gas with H₂S- and CO₂-selective polymer membranes, Part I. Process design and economics of membrane stages without recycle streams”, Journal of Membrane Science 5378 (2002) 1-30, and “Upgrading low-quality natural gas with H₂S- and CO₂-selective polymer membranes, Part I. Process design, economics, and sensitivity study of membrane stages with recycle streams”, Journal of Membrane Science 320 (2008) 108-122) and Bhide et al., (Membrane processes for the removal of acid gases from natural gas. I. Process configurations and optimization of operating conditions, Journal of Membrane Science, 81 (1993) 209-237) disclose an analysis of the merits of various membrane process configurations with and without stream recycle. Process systems without stream recycle are the least complex to implement and operate. They do not incur recompression costs. The disadvantage of these systems is a relatively high hydrocarbon loss in the permeate for a desired level of acid gas removal. Such systems are typically not capable of achieving the purity and hydrocarbon recovery requirements for NG streams with high acid gas content.

A commonly used multi-stage recycle process system uses two or more membrane stages with permeate recycle. Here, the permeate of the first stage is recompressed to the same pressure of the first stage feed stream, cooled, then fed to the second membrane stage unit. The reject of the second stage is recycled back to feed the first stage unit. The permeate of the second stage is typically vented or treated elsewhere in the facility. Such membrane systems are well known in the literature, such as Hao et al. and Bhide et al. Recompression of the permeate stream increases the separation efficiency of the subsequent membrane stage since the separation factor (permeate concentration/feed-side concentration) increases with increasing pressure ratio of feed-side: permeate pressure. It also reduces the cost of the subsequent membrane stage(s) as membrane productivity depends on difference of feed and permeate partial pressures of each component. Examples of variations on the permeate recompression concept with two or more membrane stages are disclosed in WO2009087155 to Diaz et al., and Vaidya et al., (Hydrogen sulfide-carbon dioxide membrane separation systems and processes, U.S. Pat. No. 11,420,153).

In all these works, the permeate from the first membrane stage is recompressed. When the feed gas to the first membrane stage has acid gas content, the corresponding permeate is even higher in acid gas. For example, the first membrane stage permeate may contain 30-60%, H₂S and also be relatively high in other polar contaminants such as H₂O. Recompression of such a stream is costly because of the corrosion and safety issues involved. Further US2023/0221067 discloses variations of first stage permeate recompression in order to mitigate the problems associated with compressing first stage permeate. U.S. Pat. No. 8,999,038 and Scholz et al. (Structural optimization of membrane-based biogas upgrading processes, Journal of Membrane Science 474 (2015) 1-10) disclose a membrane process system which avoids recompression of the first stage permeate. In this system a compressed feed (e.g., biogas) is fed to a first membrane stage with permeate enriched in acid gas, e.g., CO₂, withdrawn at an intermediate pressure. The acid gas rejected from the first stage is further reduced in a second stage with 2nd stage permeate recycled to feed compressor suction. The reject from the 2nd stage is the acid gas reduced hydrocarbon product. The intermediate pressure permeate stream from the first stage is fed without recompression to a third stage. The third stage reject is also recycled to suction of the feed compressor while the third stage permeate is vented or treated elsewhere in the facility. This system has also been extended to the separation of N₂ from CH₄ in U.S. Pat. No. 10,780,392. The use of an intermediate pressure for the 1st stage permeate reduces the possible separation efficiency of this stage. However, the combination of the first and third stages frequently allows the third stage permeate to be relatively highly concentrated in acid gasses and increases overall process hydrocarbon recovery. This process system uses a single compressor on the main feed line, to the suction of which, the third stage reject and second stage permeate are recycled.

US1110331856 B2 to Liu et al. discloses a 2-stage system with the 1st stage permeate withdrawn at a pressure greater than 50 psi and sent directly, without intermediate recompression, to stage 2 feed. Reject from stage 2 is recompressed and recycled to the feed gas. However, this patent teaches that the 2nd stage must be a “microporous zeolitic inorganic membrane or a combination of a microporous zeolitic inorganic membrane and a polymeric membrane.”

US1110331856 B2 also has no consideration of critical components such as moisture and heavy hydrocarbons and their associated dew points in the recompressed second stage reject stream.

U.S. Pat. No. 5,827,351 discloses another membrane process system with some similarities with US1110331856, showing a 2-stage cascaded membrane receiving pressurized output from a PSA or VPSA air separation unit. The 1st stage permeate is sent directly, without intermediate recompression, to stage 2 feed. Reject from stage 2 is either recycled to the suction of the main feed compressor or used as an intermediate purity/pressure stream elsewhere.

Several other patent applications, e.g., CN111847407A, CN116808788A, CN214764436 U, disclose the use of cascade membrane stages for high purification of He, in which more than 3 stages of membranes are required.

There is a demand for systems that separate high acidic components from natural gas using two stages of membrane without recompressing permeate stream to lower separation cost and carbon footprint.

### SUMMARY

There is disclosed a system for high acidic natural gas separation comprising:
a first membrane stage, configured to separate a feed of the high acidic natural gas into a first permeate stream, enriched in acidic gas and depleted in CH₄, withdrawn from the permeate side of the first membrane stage, and a first residue stream, enriched in CH₄ and depleted in acid gas, withdrawn from the residue side of the first membrane stage, and forwarded to a solvent absorption process for further removing acid gas;
a second membrane stage, connected to the first membrane stage in series, configured to separate the first permeate stream from the first membrane stage into a second residue stream, enriched in CH₄ and depleted in acid gas, withdrawn from the residue side of the second membrane stage and recycled back to the feed of the first membrane stage, and a second permeate stream, enriched in acidic gas and depleted in CH₄, withdrawn from the permeate side of the second membrane stage and sent to a sulfur recovery unit; and
a compressor, configured to compress the second residue stream from the second membrane stage to a pressure slightly greater than a pressure of the feed of the first membrane stage, wherein the compressed second residue stream is recycled and combined with the natural gas feed to form the feed of the first membrane stage.

In some embodiments, a pressure of the first stage permeate ranges from 60 psig to 400 psig.

In some embodiments, a ratio of permeate pressure of the first stage membrane to the second stage membrane is a square root of a feed pressure of the first membrane stage to a permeate pressure of the second stage permeate pressure +/−2.

In some embodiments, the acidic gas includes H₂S, CO₂ and H₂O.

In some embodiments, the acidic gas is H₂S.

In some embodiments, an H₂S content of the compressed second residue stream from the second membrane stage is within +/−10% of the H₂S content of the feed gas to the first membrane stage

In some embodiments, the second membrane stage is a high H₂S selectivity membrane having a selectivity of H₂S/CO₂>2.

There is also disclosed a membrane separation process for separating a high acidic natural gas comprising the steps of:
feeding a feed containing the high acidic natural gas to a first membrane stage, wherein the high acidic natural gas is separated into a first residue stream, enriched in CH₄ and depleted in acid gas, and a first permeate stream, enriched in acidic gas and depleted in CH₄;
feeding the first permeate stream to a second membrane stage, wherein the first permeate stream is separated into a second residue stream, enriched in CH₄ and depleted in acid gas, and a second permeate stream, enriched in acidic gas and depleted in CH₄;
compressing the second residue stream from the second membrane stage;
recycling the compressed second residue stream back to the feed of the first membrane stage; and
forwarding the second permeate stream to a SRU to recover sulfur.

In some embodiments, a pressure of the first permeate stream is greater than 4 bar or 60 Psi.

In some embodiments, the acidic gas is H₂S.

In some embodiments, an H₂S content of the compressed second residue stream from the second membrane stage is within +/−10% of the H₂S content of the feed gas to the first membrane stage.

In some embodiments, the process further comprising:
forwarding the first residue stream to an Amine process for further removing acidic gas; and
combining the removed acidic gas from the Amine process with the second permeate stream together to send to the SRU.

In some embodiments, a pressure of the compressed second residue stream is slightly greater than a pressure of the feed of the first membrane stage.

There is also disclosed a membrane separation process for separating a high H₂S natural gas comprising the steps of:
feeding a feed containing the high acidic natural gas to a first membrane stage, wherein the high acidic natural gas is separated into a first residue stream, enriched in CH₄ and depleted in H₂S, and a first permeate stream, enriched in H₂S and depleted in CH₄;
feeding the first permeate stream to a second membrane stage, wherein the first permeate stream is separated into a second residue stream, enriched in CH₄ and depleted in H₂S, and a second permeate stream, enriched in H₂S and depleted in CH₄;
compressing the second residue stream from the second membrane stage;
recycling the compressed second residue stream back to the feed of the first membrane stage; and
forwarding the second permeate stream to a SRU to recover sulfur.

In some embodiments, a pressure of the first permeate stream is greater than 4 bar or 60 Psi.

In some embodiments, an H₂S content of the compressed second residue stream from the second membrane stage is within +/−10% of the H₂S content of the feed gas to the first membrane stage.

In some embodiments, the process further comprising:
forwarding the first residue stream to an Amine process for further removing acidic gas; and
combining the removed acidic gas first residue stream from the Amine process with the second permeate stream together to send to the SRU.

In some embodiments, a pressure of the compressed second residue stream is slightly greater than a pressure of the feed of the first membrane stage.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a block diagram of an exemplary embodiment of a hybrid process in accordance with the present invention;

FIG. 2 is a block diagram of a two-stage membrane process configuration in accordance with the present invention;

FIG. 3 is a block diagram of a single stage membrane process configuration in comparison; and

FIG. 4 is a block diagram of a two-stage membrane process configuration with permeate recompression in comparison.

### DESCRIPTION OF PREFERRED EMBODIMENTS

Disclosed are two-membrane stage systems for high acidic natural gas separation operated at a pressure higher than ambient pressure. The high acidic natural gas may contain H₂S, CO₂ and/or H₂O. More specifically, the disclosed are two-membrane stage systems for high H₂S natural gas separation at a pressure higher than ambient pressure. The disclosed systems do not use an intermediate compressor for the high H₂S natural gas separation. The disclosed systems use two membrane stages, a first membrane stage and a second membrane stage, with a compressor for recompression of a residue stream from the second membrane stage. The recompressed second stage residue stream is then recycled back into a main feed stream for the first membrane stage. The disclosed system is aimed at natural gas separation operated at pressure greater than ambient pressure, preferably greater than 4 bar, or around 60 psi. The disclosed system completely avoids recompression of a first stage permeate which has high acid gas content.

The disclosed systems are designed to a perm-selectivity associated with polymeric membranes in both stages.

The first membrane stage and second membrane stage, each contains a plurality of gas separation membranes, each of the plurality of the gas separation membranes may be any types of gas separation membranes. The disclosed method of using gas separation membranes is not limited to the types of the gas separation membranes and in fact suitable to any gas separation membranes including existing and emerging gas separation membranes. For example, each of the plurality of the gas separation membranes may be made of one or more of fluoropolymers, copolymers of polyether-polyamide, polyimides, polysulfones and polymers of intrinsic morphology (PIMs). Alternatively, each of the plurality of gas separation membranes may be a composite hollow fiber membrane comprising a separation layer disposed on a substrate layer, the separation layer being made of one or more of fluoropolymers, copolymers of polyether-polyamide, polyimides, polysulfones, and polymers of intrinsic morphology (PIMs), the substrate layer being made of one or more of polysulfone, polyvinyledene fluoride, polyimide, polyether ketone, and polyether ether ketone.

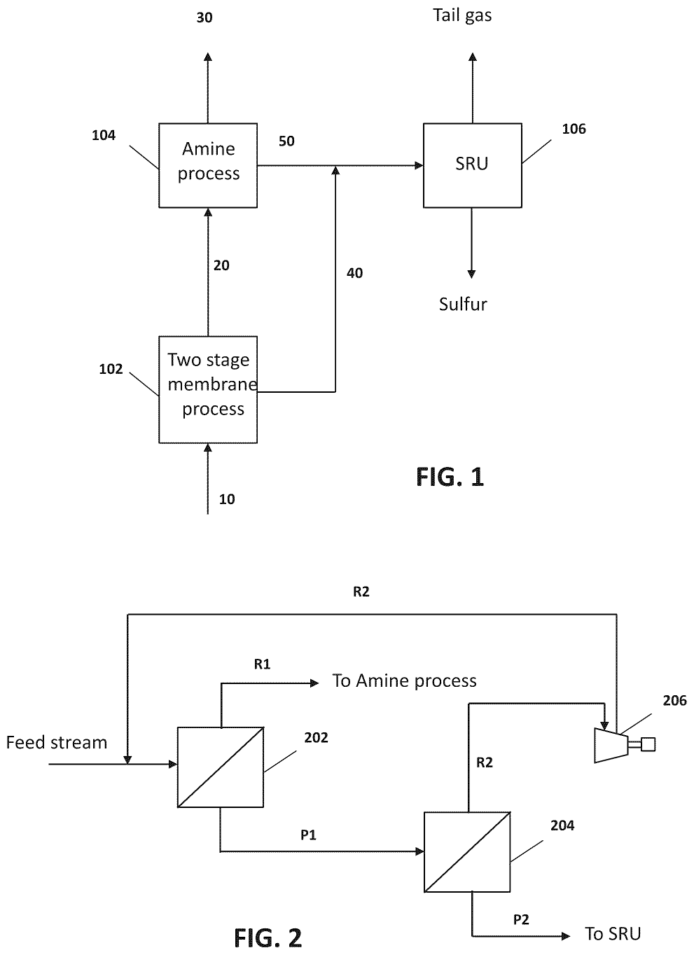

The disclosed system for natural gas sweetening includes a two-membrane stage system in combination with an amine process (i.e., a solvent absorption process) and a sulfur recovery process using a SRU, as shown in FIG. 1. In this membrane-amine-SRU system, feed stream 10, which may be a sour NG feed, is fed to two stage membrane system 102, where an acid gas concentration in the feed stream is reduced and acid gas 40 from the permeate of two stage membrane system 102 is produced. The acid gas reduced feed stream or a residue gas stream 20 is sent to amine process 104, where remaining acid gas 50 is removed from residue gas stream 20 and sweet NG 30 is produced. Then acid gas 40 from two stage membrane system 102 is combined with remaining acid gas 50 removed by amine process 104 and sent to SRU 106, where sulfur is separated from a tail gas.

An more detailed embodiment of two-stage membrane system 102 is shown in FIG. 2, which contains first membrane stage 202, second membrane stage 204 and compressor 206. A pressure of first stage permeate (P1) and a pressure of the second stage permeate (P2) may be higher than ambient pressure. The pressure of the first stage permeate (P1) may be preferably higher than 4 bar or 60 psig, more preferably between 60 psig and 400 psig. The pressure of the second stage permeate (P2) may be preferably between 1 and 100 psig. Here, throughout the context, the value of psig is equal to the value of psi. A feed stream containing a sour gas or a high acidic natural gas (e.g., ˜1000 psig with ˜20% H₂S, ˜10% CO₂) is combined with recycled stream R2 (see below) forming a high pressure and highly sour NG feed, which is fed to first membrane stage 202. Acid gas contained in the high pressure and highly sour NG feed selectively permeates through membrane 202 into permeate side forming first stage permeate P1, enriched in acidic gas. First stage permeate P1 is then sent to second membrane stage 204 directly without recompression. First stage residue R1, enriched in CH₄ and/or hydrocarbon, is sent to Amine process 104 to further remove acid gas. Second residue stream R2 from second membrane stage 204, which contains less acid gas than first stage permeate P1, enriched in CH₄ and/or hydrocarbon, is recompressed by compressor 206 and recycled back (R2) to the feed stream of first membrane stage 202. Second stage permeate P2, highly enriched in acid gas, is sent to SRU 106 to recover Sulphur. Second stage permeate P2 may combine with the acid gas (amine vent) recovered by Amine process 104 from R1 and sent to SRU 106 to recover sulfur (not shown), as shown in FIG. 1.

First stage permeate P1 is kept at an intermediate pressure to provide reasonable driving force for second membrane stage 204 without a need for an intermediate compressor. In this embodiment, Feed stream (F) pressure/P2 pressure=(F pressure/P1 pressure)×(P1 pressure/P2 pressure), as a first approximation, ignoring pipeline and equipment pressure drops. As a rule of thumb, P1 pressure should be chosen so that a pressure ratio of P1 pressure to P2 pressure is the square root of F pressure/P2 pressure. P1 pressure range may be varied depending on equipment and membrane pressure capabilities and parasitic pressure drop considerations, so that this ratio of P1 pressure/P2 pressure is typically within +/−2 of the above calculation.

The pressure ratios in equation above, in combination with the membrane selectivity affect the purity and extent of acid gas removal. In order to protect SRU 106, typically, the hydrocarbon content to be sent to the SRU, that is, second stage stream P2 in combination with the acid gas recovered by the Amine process from R1, has to be less than 3%.

In this embodiment, only one compressor is used at second residue stream R2 from second membrane stage 204. Second stage residue stream R2 is a smaller volume stream with lower content of acid gas and moisture than those of first and second permeate streams P1 and P2. Advantageously, sufficient membrane area is provided in stage 2 so that the acid gas content of recycled stream R2 matches the acid content of the feed stream; for example the H₂S concentration of R2 will be +/−10% of the H₂S concentration of the main feed stream. Both acid gas and moisture are preferentially concentrated into first and second permeate streams P1 and P2. This further lowers the capital cost for the compressor.

The disclosed hybrid two-membrane stage with amine and SRU processes may be applied in high pressure (higher than ambient pressure) sour NG separation applications, especially but is not limited to, when high acid contents are contained in the sour NG. The disclosed two-membrane stage separation system enables:
1) efficient removal of acid gas;
2) membranes to be operated under practical and reasonable conditions;
3) compressor to be operated under a less acid gas and moisture sensitive environment than operated in between the two membrane stages; and
4) lower OPEX and lower carbon footprint than compressing first stage permeate stream P1.

The advantages of the disclosed hybrid two-membrane stage with amine and SRU processes are:
1) when handling high acid NG, the biggest disadvantage of an amine stand-alone system or process is a requirement for high circulation rate of amine solution, which results in impractical high corrosion rates and less stable operation of the amine contactors. It may also result in requiring more than one regeneration train. On the other hand, a membrane stand-alone system has its own drawbacks, including high membrane cost for deep reduction of acid gas and too high hydrocarbon losses. Therefore, hybridizing the membrane process to remove bulk acid gas upstream of the amine process may be an economically attractive alternative to treat highly sour NG.
2) Compared with one single stage, the two-membrane stage process increases the recovery of the less permeable components of CH₄ and other hydrocarbons, which increases the sales value of the NG. Also, the two-membrane stage process helps in meeting the requirement that the hydrocarbon (HC) content in the combined permeate stream from the second membrane stage in comb+the acidic gas from the Amine process to the SRU should be <3%. In addition, as may be seen below in “Comparison Example 1”, while one membrane stage is the most inexpensive option from the point of view of membrane and compression capex costs, too high HC losses and HC concentration in the SRU feed make this an uneconomic proposition.
3) The disclosed is aimed at high pressure natural gas, higher than ambient pressure, preferably higher than 10 bar or 150 psig, which requires no large compressing energy upfront. The disclosed requires no intermediate compressor in between the two membrane stages, further saving compressing energy. The disclosed requires a relatively small compressor for compressing and pumping the second stage residue stream back to the feed of the first membrane stage.
4) The membrane and compressor operating conditions in the disclosed method are more economical to procure and operate. After being concentrated by the first membrane stage membrane, acid gas content in the feed to the second membrane stage has been increased to a much higher level (e.g., H₂S 0-60%), so are the other polar contaminants such as H₂O. If deploying an intermediate compressor to boost the second stage feed pressure to 1000 psig, the intermediate compressor and the second membrane stage bundle need to be capable of handling a 1000 psig NG containing 40-60% H₂S. This may be an impractical condition for compressor and membranes due to membrane material degradation, corrosion and safety requirements for piping and membrane housing materials, etc. In the disclosed system, a compressor is only deployed at the second membrane stage residue stream, and the second membrane stage residue stream is a much smaller volume stream with much lower content of acid gas and moisture comparing to the first stage permeate stream. The acid gas and moisture are accumulated into the permeate streams, rather than the second membrane stage residue stream. This further lowers the cost for the compressor.

When the two membrane stage separation process is operated at a higher pressure, such as 300 to 1000 psig, a greater purification of the high acidic natural gas may be possible.

The disclosed embodiment also envisages two different membrane types used in stages 1 and 2 (204 and 206). The membranes may have different acid gas perm-selectivity as well as membrane module configuration (hollow fiber vs spiral wound or shell fed hollow fiber vs bore fed hollow fiber). In a preferred scheme, membrane 204, which operates at the highest feed pressure, may be a polyimide hollow fiber module with shell-side feed while membrane 206 which operates at lower feed pressure than that in membrane 204 may be a polyether-amide based hollow fiber module with bore-side feed. The sulfur recovery (SRU) operation may be further enhanced not only by choosing membranes with high acid gas/hydrocarbon (e.g., H₂S/CH₄) selectivity but also high H₂S/CO₂ selectivity (e.g., H₂S/CO₂>2). High H₂S/CO₂ selectivity may typically be obtained through solubility based selective membranes such as those based on polyether-amide.

Operation of the disclosed two-membrane stage separation system was modelled though an Air Liquide software. In the examples that follow, pressures are approximate and will vary to account for piping friction losses, pressure drop in ancillary equipment and water head in Amine and SRU processes.

### EXAMPLES

The following non-limiting examples are provided to further illustrate embodiments of the invention. However, the examples are not intended to be all inclusive and are not intended to limit the scope of the inventions described herein.

Unless stated otherwise, calculations have been done with 12″ diameter membrane modules. The number of modules is proportional to the total membrane area and cost. The membrane permeances (gas permeance units (GPU) 10⁻⁶ cm³(STP)/cm²-sec-cm (Hg) used for these calculations for various gases are listed in Table 1.

TABLE 1

| Gas | GPU |
|---|---|
| CO₂ | 122 |
| H₂S | 235 |
| CH₄ | 14 |
| N₂ | 16.3 |
| H₂O | 750 |
| C2+ hydrocarbons | 8.4 |

Calculations were done through a Hysys-Aspen™ based proprietary membrane performance simulation tool for feed bases shown below in Table 2:

TABLE 2

| | Feed | | 500 million cubic feet per day (MMcfd) |
|---|---|---|---|
| Pressure [psig] | | | 1000 |
| Temperature [F.] | | | 136 |
| | Molar % | CO₂ | 7.2 |
| | | H₂S | 20.1 |
| | | CH₄ | 55.1 |
| | | N₂ | 12.9 |
| | | H₂O | 0.03 |
| | | C₂H₆ | 4.74 |

In all cases, the membrane process residue stream (e.g., R1 in FIG. 2) which is the inlet to the amine step contains 8.0% H₂S.

### Comparison Example 1

### Single Membrane Stage System

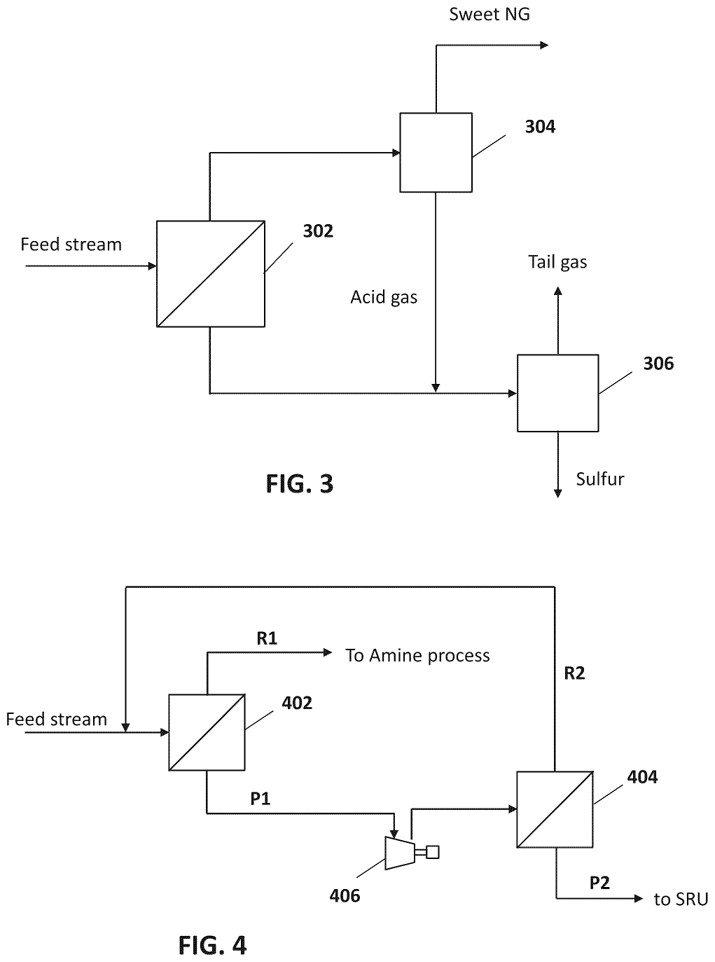

The single-membrane stage system as shown in FIG. 3 was simulated with the membrane properties defined above. The permeate pressure is at 15 psig. A sour NG is fed to the single membrane stage, which contains single membrane stage 302, Amine process 304 and SRU 306. A feed stream is fed to single membrane stage 302. The residue stream from the single membrane stage, enriched in CH₄ (or HC) and depleted in acid gas CO₂ and H₂S, is sent to Amine process 304 to further remove the acid gas and produce sweet NG. The permeate stream from the single membrane stage, enriched in acid gases H₂S and CO₂ and depleted in CH₄ (or HC), combined with the acid gas removed from Amine process 304, is sent to SRU 306 to recover Sulfur from a tail gas. To achieve 8% H₂S in the residue stream to the Amine step, 89 modules are required. The HC loss in the permeate (at 15 psig) to SRU 306 would be relatively high at 13% with a total HC (C1+) of 27.5 mole %. There are no significant additional compression costs, while this is the most inexpensive option based on membrane and compression costs, the HC losses and HC concentration in the SRU feed make this single stage system an uneconomic proposition. A stream table for this comparison example is shown in Table 3.

TABLE 3

| | Sour Gas/1^{st} stage | | |
|---|---|---|---|
| | feed | R1 to Amine | P1 to SRU |
| Temperature [F.] | 136 | 109.8 | 122.8 |
| Pressure [psig] | 1000 | 905.8 | 15.3 |
| Molar Flow [Nm³/h] | 1000 | 717.6 | 282.4 |
| Component mole % | | | |
| CO₂ | 7.19 | 4.22 | 14.73 |
| H₂S | 20.06 | 8.02 | 50.66 |
| CH₄ | 55.05 | 66.44 | 26.11 |
| N₂ | 12.93 | 15.26 | 7.00 |
| H₂O | 0.0300 | 0.0068 | 0.0889 |
| C₂₊ | 4.74 | 6.05 | 1.42 |

### Comparison Example 2

### Two Membrane Stage System with Intermediate Permeate Recompression

The two-membrane stage system shown in FIG. 4 was simulated with the same membrane properties defined in Table 1 for both stages, which contains first membrane stage 402, second membrane stage 404 and compressor 406. Both first and second stage permeate pressures were at 15 psig. First stage permeate stream P1 was recompressed by compressor 406 reaching to slightly above a feed pressure and then sent to second membrane stage 404. First stage residue stream R1 was sent to an Amine process to further remove acid gas. Second stage residue stream R2 from second membrane stage 404 was recycled to a main feedstock of first membrane stage 402. Second stage permeate stream P2 was sent to a SRU to recover sulfur. To achieve 8% H₂S in the first stage residue stream R1 to the Amine process, 128 modules would be required. The HC loss in second stage permeate P2 to SRU would be only 2.4% with a total HC (C1+) of 7.7 mole %. A stream table for this comparison example is shown in Table 4. The permeate recompression requires 42 MW. The first stage permeate stream P1 required to be recompressed is highly acidic (containing combined>65% H₂S and CO₂) and contains high moisture content of 629 mg/m³.

TABLE 4

| | | Sour | 1stg | R1 to | | Compressed P1/ | | |
|---|---|---|---|---|---|---|---|---|
| | | Gas | feed | Amine | P1 | 2^{nd} stage feed | R2 | P2 |
| Temperature | | 136 | 136 | 110 | 123 | 136 | 136 | 136 |
| [F.] | | | | | | | | |
| Pressure [psig] | | 1000 | 1000 | 904 | 15 | 1040 | 1005 | 15 |
| Molar Flow | | 1000 | 1127 | 810 | 318 | 318 | 127 | 191 |
| [Nm³/h] | | | | | | | | |
| Molar % | CO₂ | 7.19 | 7.62 | 4.51 | 15.5 | 15.5 | 11.0 | 18.6 |
| | H₂S | 20.1 | 20.0 | 8.07 | 50.3 | 50.3 | 19.2 | 71.0 |
| | CH₄ | 55.1 | 54.8 | 66.2 | 25.8 | 25.8 | 52.8 | 7.68 |
| | N₂ | 12.9 | 13.0 | 15.4 | 7.00 | 7.00 | 13.9 | 2.37 |
| | H₂O | 0.03 | 0.028 | 0.00644 | 0.0827 | 0.0827 | 0.0119 | 0.13 |
| | C2+ | 4.74 | 4.54 | 5.80 | 1.35 | 1.35 | 2.98 | 0.255 |

### Example 1

### Two Membrane Stage System without Intermediate Permeate Recompression

The two membrane stage system as shown in FIG. 2 was simulated with the membrane properties defined in Table 1 for both stages. In this embodiment, first stage permeate pressure was 175 psig and second stage permeate pressure was 15 psig. In this example the pressure ratios of feed/permeate pressure are 5.3 in stage 1 and 6.3 for stage 2, while the square root of the ratio of feed/P2 pressure is 5.8. First stage permeate P1 was sent to second membrane stage 204 directly without recompression. First stage residue R1 was sent to an Amine process to further remove acid gas. Residue stream R2, which contained less acid from second membrane stage 204 was recompressed by compressor 206 and recycled back to first membrane stage 202. Second stage permeate P2 was sent to a SRU to recover sulfur. To achieve 8% H₂S in residue stream R1 to Amine process, 396 modules may be required. The HC loss in the first stage permeate P1 to the SRU would be at 2.9% with a total HC (C1+) of 8.9 mole %. A stream table for this example is shown in Table 5. Second stage residue R2 recompression required only 16 MW which is significantly less than the power calculated for Comparison Example 2, Table 4. In addition second stage residue stream R2 required to be recompressed is significantly lower in acid gas and moisture content than first stage permeate stream P1 to be recompressed in Comparison Example 2 and FIG. 4.

TABLE 5

| | | Sour | R1 to | | | P2 to | 1stg | Recycle |
|---|---|---|---|---|---|---|---|---|
| | | Gas | Amine | P1 | R2 | SRU | feed | R2 |
| Temperature [F.] | | 136 | 104 | 120 | 107 | 119 | 135 | 136 |
| Pressure [psig] | | 1000 | 975 | 175 | 160 | 15 | 1000 | 1029 |
| Molar Flow | | 1000 | 803 | 510 | 314 | 196 | 1313 | 313 |
| [Nm³/h] | | | | | | | | |
| Molar % | CO₂ | 7.19 | 4.37 | 15.5 | 13.5 | 18.6 | 8.69 | 13.5 |
| | H₂S | 20.1 | 7.94 | 45.5 | 30.3 | 69.6 | 22.5 | 30.3 |
| | CH₄ | 55.1 | 66.4 | 29.4 | 42.5 | 8.64 | 52.1 | 42.5 |
| | N₂ | 12.9 | 15.4 | 7.98 | 11.3 | 2.66 | 12.5 | 11.3 |
| | H₂O | 0.03 | 0.00654 | 0.0625 | 0.023 | 0.126 | 0.0284 | 0.0231 |
| | C2+ | 4.74 | 5.83 | 1.54 | 2.33 | 0.29 | 4.16 | 2.33 |

### Example 2

### Two-Membrane Stage without Intermediate Permeate Recompression System Using High H₂S Selectivity Membrane in the Second Membrane Stage

Referring to FIG. 2, this system is similar to Example 1, but with a modification of the second membrane stage 204 that is based on a bore feed membrane with high H₂S selectivity. The second membrane stage 204 in this Example has the permeance profile shown below in Table 6.

TABLE 6

| Gases | GPU |
|---|---|
| CO₂ | 81.5 |
| H₂S | 325.8 |
| Methane | 7.8 |
| Nitrogen | 4.1 |
| H₂O | 750 |
| Ethane | 7.6 |
| Propane | 8.4 |
| i-Butane | 7.6 |
| n-Butane | 7.5 |
| i-Pentane | 7.5 |
| n-Pentane | 7.5 |
| n-Heptane | 8.4 |
| Toluene | 5.4 |
| n-Hexane | 7.3 |

With 8% H₂S in first stage residue stream R1 to Amine step, the HC loss from second stage permeate P2 to the SRU would be at only 1.3% with a total HC (C1+) of 4.4 mole %. A stream table for this example is shown below in Table 7. Second stage residue stream R2 recompression at the second membrane stage required only 13 MW. Again the stream (R2) to be recompressed has lower acid content (CO₂+H₂S˜36%) and lower water content (175 mg/m³) than the stream (P1) to be compressed in Comparison Example 2.

TABLE 7

| | | Sour | R1 to | | | P2 to | 1stg | Recycle |
|---|---|---|---|---|---|---|---|---|
| | | Gas | Amine | P1 | R2 | SRU | feed | R2 |
| Temperature | | 136 | 110 | 123 | 108 | 123 | 136 | 136 |
| [F.] | | | | | | | | |
| Pressure | | 1000 | 963 | 175 | 155 | 15 | 1000 | 1029 |
| [psig] | | | | | | | | |
| Molar Flow | | 1000 | 829 | 424 | 253 | 171 | 1252 | 252 |
| [Nm³/h] | | | | | | | | |
| Molar % | CO₂ | 7.19 | 5.18 | 17.5 | 17.9 | 16.8 | 9.34 | 17.9 |
| | H₂S | 20.1 | 8.10 | 42.4 | 18.3 | 78.0 | 19.7 | 18.3 |
| | CH₄ | 55.1 | 65.6 | 30.2 | 47.8 | 4.23 | 53.6 | 47.9 |
| | N₂ | 12.9 | 15.5 | 8.29 | 13.5 | 0.626 | 13.0 | 13.5 |
| | H₂O | 0.03 | 0.00746 | 0.0622 | 0.0100 | 0.139 | 0.0260 | 0.0100 |
| | C2+ | 4.74 | 5.68 | 1.58 | 2.49 | 0.219 | 4.29 | 2.50 |

Reference herein to “one embodiment” or “some embodiments” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

As used herein, the indefinite article “a” or “an” means one or more.

As used herein, “about” or “around” or “approximately” in the text or in a claim means±10% of the value stated.

The term “ambient pressure” refers to an environment pressure approximately 1 atm or 1 bara.

The term “sour gas” or “sour NG” refers to natural gas that contains significant amounts of hydrogen sulfide (H₂S) and/or carbon dioxide (CO₂).

The standard abbreviations of the elements from the periodic table of elements are used herein. It should be understood that elements may be referred to by these abbreviations (e.g., Si refers to silicon, N refers to nitrogen, O refers to oxygen, C refers to carbon, etc.).

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

Although the subject matter described herein may be described in the context of illustrative implementations to process one or more computing application features/operations for a computing application having user-interactive components the subject matter is not limited to these particular embodiments. Rather, the techniques described herein may be applied to any suitable type of user-interactive component execution management methods, systems, platforms, and/or apparatus.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

We claim:

1. A system for acidic natural gas separation, the system comprising:
a first membrane stage, configured to separate a feed of the high acidic natural gas into a first permeate stream, enriched in acidic gas and depleted in CH₄, withdrawn from the permeate side of the first membrane stage, and a first residue stream, enriched in CH₄ and depleted in acid gas, withdrawn from the residue side of the first membrane stage, and forwarded to a solvent absorption process for further removing acid gas;
a second membrane stage, connected to the first membrane stage in series, configured to separate the first permeate stream from the first membrane stage into a second residue stream, enriched in CH₄ and depleted in acid gas, withdrawn from the residue side of the second membrane stage and recycled back to the feed of the first membrane stage, and a second permeate stream, enriched in acidic gas and depleted in CH₄, withdrawn from the permeate side of the second membrane stage and sent to a sulfur recovery unit; and
a compressor, configured to compress the second residue stream from the second membrane stage to a pressure slightly greater than a pressure of the feed of the first membrane stage, wherein the compressed second residue stream is recycled and combined with the natural gas feed to form the feed of the first membrane stage.

2. The system of claim 1, wherein a pressure of the first stage permeate ranges from 60 psig to 400 psig.

3. The system of claim 1, wherein a ratio of permeate pressure of the first stage membrane to the second stage membrane is a square root of a feed pressure of the first membrane stage to a permeate pressure of the second stage permeate pressure +/−2.

4. The system of claim 1, wherein the acidic gas includes H₂S, CO₂ and H₂O.

5. The system of claim 1, wherein the acidic gas is H₂S.

6. The system of claim 5, wherein an H₂S content of the compressed second residue stream from the second membrane stage is within +/−10% of the H₂S content of the feed gas to the first membrane stage.

7. The system of claim 1, wherein the second membrane stage is a high H₂S selectivity membrane having a selectivity of H₂S/CO₂>2.

8. A membrane separation process for separating an acidic natural gas, the process comprising the steps of:
feeding a feed containing the high acidic natural gas to a first membrane stage, wherein the high acidic natural gas is separated into a first residue stream, enriched in CH₄ and depleted in acid gas, and a first permeate stream, enriched in acidic gas and depleted in CH₄;
feeding the first permeate stream to a second membrane stage, wherein the first permeate stream is separated into a second residue stream, enriched in CH₄ and depleted in acid gas, and a second permeate stream, enriched in acidic gas and depleted in CH₄;
compressing the second residue stream from the second membrane stage;
recycling the compressed second residue stream back to the feed of the first membrane stage; and
forwarding the second permeate stream to a SRU to recover sulfur.

9. The membrane separation process of claim 8, wherein the acidic gas is H₂S.

10. The membrane separation process of claim 8, wherein an H₂S content of the compressed second residue stream from the second membrane stage is within +/−10% of the H₂S content of the feed gas to the first membrane stage.

11. The membrane separation process of claim 8, wherein a pressure of the first permeate stream is greater than 4 bar or 60 Psi.

12. The membrane separation process of claim 8, further comprising:
forwarding the first residue stream to a solvent absorption for further removing acidic gas; and
combining the removed acidic gas from the solvent absorption with the second permeate stream together to send to a sulfur recovery unit.

13. The membrane separation process of claim 8, wherein a pressure of the compressed second residue stream is slightly greater than a pressure of the feed of the first membrane stage.

14. A membrane separation process for separating an H₂S-containing natural gas, the process comprising the steps of:
feeding a feed containing the high acidic natural gas to a first membrane stage, wherein the high acidic natural gas is separated into a first residue stream, enriched in CH₄ and depleted in H₂S, and a first permeate stream, enriched in H₂S and depleted in CH₄;
feeding the first permeate stream to a second membrane stage, wherein the first permeate stream is separated into a second residue stream, enriched in CH₄ and depleted in H₂S, and a second permeate stream, enriched in H₂S and depleted in CH₄;
compressing the second residue stream from the second membrane stage;
recycling the compressed second residue stream back to the feed of the first membrane stage; and
forwarding the second permeate stream to a SRU to recover sulfur.

15. The membrane separation process of claim 14, wherein a pressure of the first permeate stream is greater than 4 bar or 60 Psi.

16. The membrane separation process of claim 14, wherein an H₂S content of the compressed second residue stream from the second membrane stage is within +/−10% of the H₂S content of the feed gas to the first membrane stage.

17. The membrane separation process of claim 14, further comprising:
forwarding the first residue stream to a solvent absorption for further removing acidic gas; and
combining the removed acidic gas first residue stream from the solvent absorption with the second permeate stream together to send to the SRU.

18. The membrane separation process of claim 14, wherein a pressure of the compressed second residue stream is slightly greater than a pressure of the feed of the first membrane stage.
